(19) United States
(12) Patent Application Publication
(10) Pub. No.: US 2015/0185839 A1
(43) Pub. Date: Jul. 2, 2015

(54) MULTI-SCREEN WEARABLE ELECTRONIC DEVICE FOR WIRELESS COMMUNICATION

(71) Applicants: Aleksander Magi, Aloha, OR (US); Ryan S. Brotman, Beaverton, OR (US)

(72) Inventors: Aleksander Magi, Aloha, OR (US); Ryan S. Brotman, Beaverton, OR (US)

(21) Appl. No.: 14/142,788

(22) Filed: Dec. 28, 2013

(51) Int. Cl. G06F 3/01; G06F 3/14; G06F 3/041

(52) U.S. Cl. CPC G06F 3/014; G06F 3/0412; G06F 3/1423; G09G 2370/16

(57) ABSTRACT

Particular embodiments described herein provide for a wearable electronic device. One particular implementation of a wearable electronic device may include a plurality of touch display screens in which each touch display screen is configured to display one or more images and includes a touch input device configured to receive a user interaction. The wearable electronic device may further include a control module in communication with the plurality of touch display screens. The control module includes a processor configured to receive a first interaction from a first touch display screen of the plurality of display screens, and send a first message including first information indicative of the first interaction and a first display screen identifier associated with the first touch display screen to a second electronic device.

### TECHNICAL FIELD

Embodiments described herein generally relate to a multi-screen wearable electronic device for wireless communication.

### BACKGROUND

End users have more electronic device choices than ever before. A number of prominent technological trends are currently afoot (e.g., mobile electronic devices, smaller electronic devices, increased user connectivity, etc.), and these trends are changing the electronic device landscape. One of the technological trends currently afoot is electronic devices that can be worn by users, sometimes referred to as wearable electronic devices. Wearable electronic devices can be worn on a user's wrist, arm, ankle, etc. Electronic devices such as mobile phones provide features for typing and sending messages; however, this often requires the user to tediously type messages using a small interactive keyboard on the mobile phone. Although wearable electronic devices are quickly becoming a member of the technological ecosystem, interactions between device and user have yet to become streamlined and generally suffer from the same limitations as mobile phones for communicating messages.

### BRIEF DESCRIPTION OF THE DRAWINGS

Embodiments are illustrated by way of example and not by way of limitation in the FIGURES of the accompanying drawings, in which like references indicate similar elements and in which:

FIGS. 1A-1C are simplified views illustrating a wearable electronic device for multi-screen communication in accordance with one embodiment of the present disclosure;

FIG. 2 illustrates an embodiment of an example procedure for multi-screen communication using wearable electronic device;

FIG. 3 is a simplified block diagram illustrating example logic that may be used to execute activities associated with wearable electronic device 10 in accordance with one embodiment;

FIG. 4 is a simplified block diagram illustrating an embodiment of a communication system for wireless communication between a first wearable electronic device and a second wearable electronic device;

FIGS. 5A-5C are simplified illustrating a wearable electronic device for multi-screen communication in accordance with another embodiment of the present disclosure;

FIG. 6 illustrates an embodiment of an example procedure for multi-screen communication using the wearable electronic device of FIGS. 5A-5C;

FIGS. 7A-7E illustrate example interactions of a user of the wearable electronic device in accordance with various embodiments; and

FIG. 8 is a simplified flow diagram illustrating potential operations for the wearable electronic device in accordance with one embodiment of the present disclosure.

The FIGURES of the drawings are not necessarily drawn to scale, as their dimensions can be varied considerably without departing from the scope of the present disclosure.

### DETAILED DESCRIPTION OF EXAMPLE EMBODIMENTS

### Overview

Example embodiments described herein provide for a wearable electronic device, such as an electronic bracelet, that includes a circuit board coupled to a plurality of electronic components (which may include any type of components, elements, circuitry, etc.). One particular implementation of a wearable electronic device may include a plurality of touch display screens in which each touch display screen is configured to display one or more images and includes a touch input device configured to receive a user interaction. The wearable electronic device may further include a control module in communication with the plurality of touch display screens. The control module includes a processor configured to receive a first interaction from a first touch display screen of the plurality of display screens, and send a first message including first information indicative of the first interaction and a first display screen identifier associated with the first touch display screen to a second electronic device.

In a particular embodiment, the wearable electronic device includes a strap portion, wherein the plurality of touch display screens are at least partially disposed upon the strap portion. In another embodiment, the first message further includes a first device identifier associated with the wearable electronic device. In still another embodiment, the second electronic device includes a second wearable electronic device. In another embodiment, the second electronic device is configured to provide a first presentation of the first interaction using a first display screen of the second electronic device.

In another embodiment, the first touch display screen of the wearable electronic device is associated with the first display screen of the second electronic device. In still another embodiment, the processor is further configured to receive a second interaction from a second touch display screen of the plurality of display screens, and send a second message including second information indicative of the second interaction and a second display screen identifier associated with the second touch display screen to the second electronic device.

In still another embodiment, the second electronic device is configured to provide a first presentation of the first interaction using a first display screen of the second electronic device, and provide a second representation of the second interaction using a second display screen of the second electronic device. In another embodiment, the first interaction includes a pattern of interactions provided to a plurality of the touch display screens of the wearable electronic device, and wherein the first information of the first message is indicative of the pattern of touch inputs.

In another embodiment, the processor is further configured to receive a third message including third information indicative of a third interaction provided to a third display screen of the second electronic device, and a third display screen identifier associated with the third display screen of the second electronic device. In still another embodiment, the processor is further configured to provide a third presentation of the third interaction using a third touch display screen of the plurality of touch display screens, wherein the third touch display screen of the wearable electronic device is associated with the third display screen of the second electronic device.

Another particular implementation of a wearable electronic device includes a plurality of touch display screens in which each touch display screen configured to display one or more images and including a touch input device configured to receive a user interaction. The wearable electronic device further includes a control module in communication with the plurality of touch display screens. The control module includes logic, at least a portion of which is partially implemented in hardware, the logic configured to receive a first interaction from a first touch display screen of the plurality of display screens, and send a first message including first information indicative of the first interaction and a first display screen identifier associated with the first touch display screen to a second electronic device.

A particular implementation of at least one computer readable storage medium comprises instructions, wherein the instructions when executed by at least one processor cause the at least one processor to receive a first interaction from a first touch display screen of a plurality of display screens of a wearable electronic device, wherein each touch display screen is configured to display one or more images and including a touch input device configured to receive a user interaction, and send a first message including first information indicative of the first interaction and first display screen identifier associated with the first touch display screen to a second electronic device.

### Example Embodiments

The following detailed description sets forth example embodiments of apparatuses, methods, and systems relating to configurations for a wearable electronic device for measuring. Features such as structure(s), function(s), and/or characteristic(s), for example, are described with reference to one embodiment as a matter of convenience; various embodiments may be implemented with any suitable one or more of the described features.

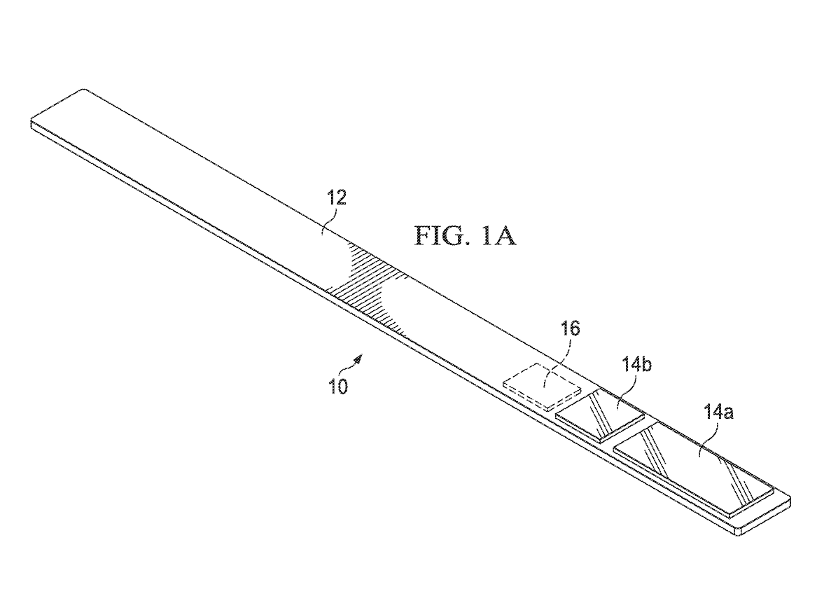

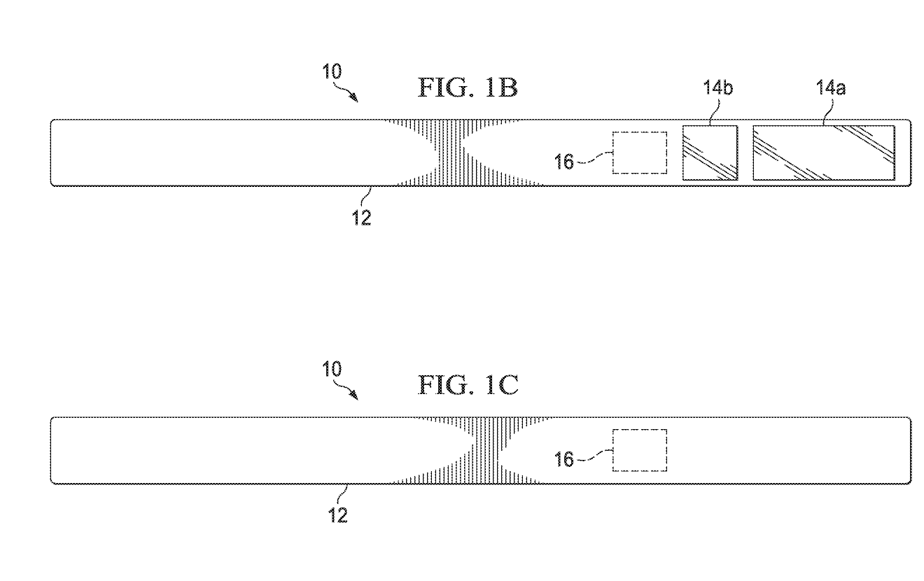

FIG. 1A is a simplified orthographic view illustrating a wearable electronic device 10 for multi-screen communication in accordance with one embodiment of the present disclosure. Wearable electronic device 10 can include a strap portion 12 having a first touch display screen 14a and a second touch display screen 14b disposed at least partially on an upper surface of strap portion 12. Wearable electronic device 10 further includes a control module 16 disposed at least partially within or upon a surface of strap portion 12. Control module 16 is in communication with each of first touch display screen 14a and second display screen 14b.

In at least one embodiment, strap portion 12 may be of a semi-rigid construction to allow strap portion 12 to be wrapped around a wrist of a user. In still other embodiments, strap portion 12 may include clasp portion at opposing ends of strap portion 12 are configured to be coupled together to allow wearable electronic device 10 to be worn around a wrist of a user. In one or more embodiments, one or more of strap portion 12, control module 16, first touch display screen 14a and second touch display screen 14b are composed of a flexible or semi-flexible material to allowing bending to facilitate wearing of wearable electronic device 10 around the wrist or other body portion of the user.

In one or more embodiments, strap portion 12 may be of a solid unibody construction (as shown in FIGS. 1A-1C) or may include links, chains, cables, weaves, combinations thereof or the like. The ornamental design and material construction of strap portion 12 can be adjusted in any manner to suit any designer, manufacturer and/or vendor without departing from the scope of the embodiments described in the present disclosure.

In one or more embodiments, first touch display screen 14a and second touch display screen 14b is a screen that can be a liquid crystal display (LCD) screen, transparent LCD screen, light-emitting diode (LED) display screen, transparent LED display screen, organic light-emitting diode (OLED) display screen, transparent LED display screen or any other suitable display screen system. In one or more embodiments, one or more of first touch display screen 14a and second touch display screen 14b include a touch input device, which may include a capacitive or resistive touchscreen layer over the screen of first touch display screen 14a and/or second touch display screen 14b.

FIG. 1B is a simplified top plan view of wearable electronic device 10 in which first touch display screen 14a and second touch display screen 14b are shown disposed on the top surface of strap portion 12 so that they may be visible when wearable electronic device 10 is being worn by the user. FIG. 1C illustrates a simplified bottom view of wearable electronic device 10 showing a bottom surface of strap portion 12.

In one or more embodiments, control module 16 of wearable electronic device 10 may further include a wireless communication module configured to communicate interactions of first touch display screen 14a and/or second touch display screen 14b by a user of wearable electronic device 10 with other wireless electronic devices such as another wearable electronic device associated with another user as will be further described herein.

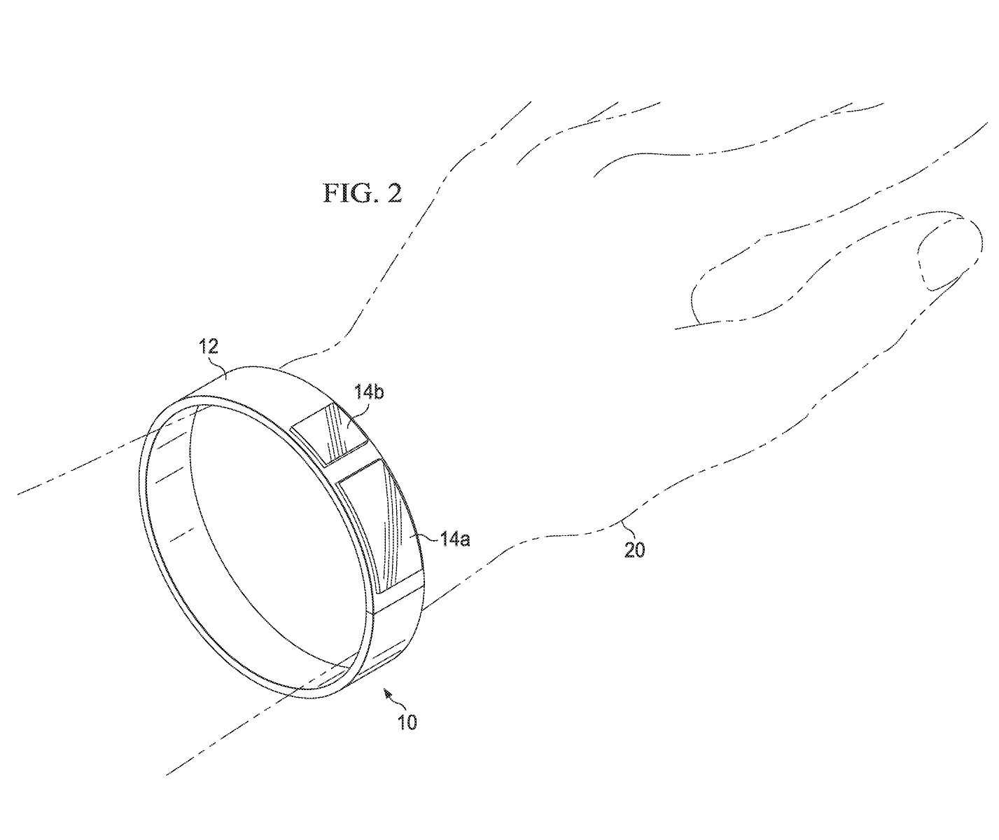

FIG. 2 illustrates an embodiment of an example procedure for multi-screen communication using wearable electronic device 10. In the embodiment illustrated in FIG. 2, wearable electronic device 10 is worn upon a wrist 20 of a user. In a particular embodiment, first touch display screen 14a is configured to a screen with a larger viewing area than that of second touch display screen 14b. In particular embodiments, the larger first touch display screen 14a may be more suitable for viewing information and for interaction than second touch display screen 14b due to the larger area, but may have a higher power consumption than that of second touch display screen 14b. In a particular embodiment, first touch display screen 14a and second touch display screen 14b may be constructed of either the same or different screen technologies. For example, in one embodiment, first touch display screen 14a may be an OLED screen and second touch display screen 14b may be an “e-ink” display. In accordance with various embodiments, first touch display screen 14a and second touch display screen 14b may operate as independent displays and/or mirrored displays to display information to the user. In a particular embodiment, the information displayed on second touch display screen 14b may include a subset of the information displayed on first touch display screen 14a.

In accordance with a particular embodiment, the user may move content from the display to another utilizing a swipe motion across one of the displays. For example, when information is currently being displayed by first touch display screen 14a, the user may swipe across first touch display screen 14a towards second touch display screen 14b. In response to receiving the touch input indicative of the swipe motion across first touch display screen 14a, control module 16 may cause the information currently being displayed by first touch display screen 14a or a subset of the information currently being displayed by first touch display screen 14a to be displayed by second touch display screen 14b. Further, in particular embodiments, control module 16 may cause first touch display screen 14a to display different information than previously displayed or to deactivate first touch display screen 14a to conserve power consumption.

Similarly, when information is currently being displayed by second touch display screen 14b, the user may swipe across second touch display screen 14b towards first touch display screen 14a. In response to receiving the touch input indicative of the swipe motion across second touch display screen 14b, control module 16 may cause the information currently being displayed by second touch display screen 14a or a subset of the information currently being displayed by first touch display screen 14a to be displayed by second touch display screen 14b. In response to receiving the touch input indicative of the swipe motion across second touch display screen 14b, control module 16 may cause the information currently being displayed by second touch display screen 14b or information in addition to that currently being displayed by second touch display screen 14b to be displayed by first touch display screen 14a. Further, in particular embodiments, control module 16 may cause second touch display screen 14b to display different information than previously displayed or to deactivate second touch display screen 14b to conserve power consumption.

Accordingly, in one or more embodiments the user is able to view content on wearable electronic device 10 by utilizing the smaller second touch display screen 14b for quick viewing and/or interaction with displayed information and more efficient power consumption, and utilizing the larger first touch display screen 14b for better visibility and interaction experience.

In various embodiments, control module 16 includes a communication module configured to communicate with other wireless electronic devices such as another multi-screen wearable electronic device associated with a second user. In an example operation according to one embodiment, a first user of wearable electronic device 10 may interact with first touch display screen 14a to generate a message to a second user associated with a second wearable electronic device. Upon receiving the message, the second wearable electronic device may be configured to activate a display screen on second wearable electronic device corresponding to first touch display screen 14a and present the message to the second user using the active display screen of the second wearable device. In still other embodiments, the first user may input a pattern of interactions using one or more of first touch display screen 14a and second touch display screen 14b and send a message representative of the pattern of interactions to the second wearable electronic device. The second wearable electronic device may be further configured to replay or reproduce the pattern of interactions using corresponding displays of the second wearable electronic device.

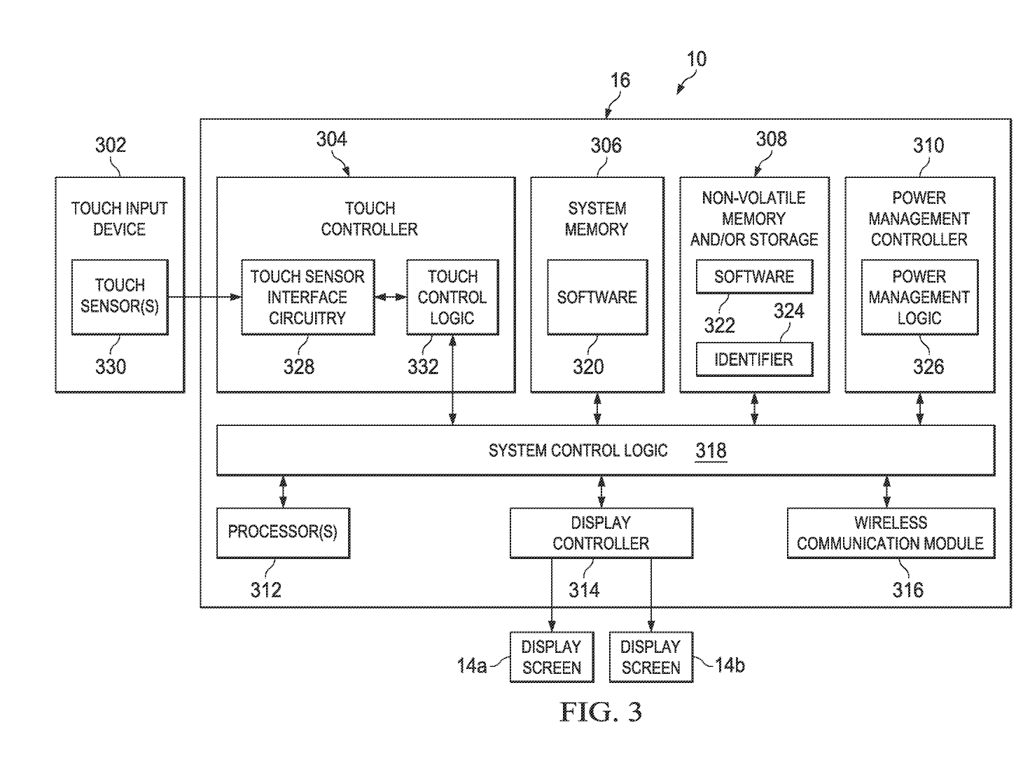

FIG. 3 is a simplified block diagram illustrating example logic that may be used to execute activities associated with wearable electronic device 10 in accordance with one embodiment. In at least one example embodiment, wearable electronic device 10 can include a touch input device 302, a touch controller 304, a system memory 306, a non-volatile memory and/or storage 308, a power management controller 310, processor(s) 312, display controller 314, and wireless communication module 316, each of which is coupled to system control logic 318. Display controller 314 is in further communication with first touch display screen 14a and second touch display screen 14b. In one or more embodiments, touch input device 302, touch controller 304, system memory 306, non-volatile memory and/or storage 308, power management controller 310, processor(s) 312, display controller 314, first touch display screen 14a, second touch display screen 14b, wireless communication module 316, and system control logic 318 may be disposed at least partially within or upon a surface of housing 16.

Hence, the basic building blocks of any wearable electronic device system (e.g., processor, controller, memory, I/O, display, etc.) can be used in conjunction with the teachings of the present disclosure. Certain components could be discrete or integrated into a System on Chip (SoC). In alternate implementations, instead of wearable electronic devices, certain alternate embodiments deal with mobile phones, tablet devices, etc.

System control logic 318, in at least one embodiment, can include any suitable interface controllers to provide for any suitable interface to at least one processor 312 and/or to any suitable device or component in communication with system control logic 318. System control logic 318, in at least one embodiment, can include one or more memory controllers to provide an interface to system memory 306. System memory 306 may be used to load and store data and/or instructions, for example, for wearable electronic device 10. System memory 306, in at least one embodiment, can include any suitable volatile memory, such as suitable dynamic random access memory (DRAM) for example. System memory 306 may store suitable software 320 and/or non-volatile memory and/or storage device(s).

Non-volatile memory and/or storage device(s) 308 may be used to store data and/or instructions, for example within software 322. Non-volatile memory and/or storage device(s) 308 may include any suitable non-volatile memory, such as flash memory for example, and/or may include any suitable non-volatile storage device(s), such as one or more hard disc drives (HDDs), solid state drives (SSDs), etc. for example. In various embodiments, non-volatile memory and/or storage 308 includes a device identifier 324 associated with wearable electronic device 10 to uniquely identify wearable electronic device 10 from among other devices that may be associated with other users.

Power management controller 310 may include power management logic 326 configured to control various power management and/or power saving functions. In at least one example embodiment, power management controller 310 is configured to reduce the power consumption of components or devices of wearable electronic device 10 that may either be operated at reduced power or turned off when one or more components of wearable electronic device is in an inactive state (e.g., not being accessed, etc.). For example, in at least one embodiment, when one or more components of wearable electronic device 10 are in an inactive state, power management controller 310 may perform one or more of the following: power down the unused portion of touch input device 302; allow one or more of processor(s) 312 to go to a lower power state if less computing power is required during times of inactivity; power down one or more of first touch display screen 14a and second touch display screen 14b, and shutdown any devices and/or components that may be unused when wearable electronic device 10 is in an inactive state. System control logic 318, in at least one embodiment, can include one or more I/O controllers to provide an interface to any suitable input/output device(s).

For at least one embodiment, at least one processor 312 may be packaged together with logic for one or more controllers of system control logic 318. In at least one embodiment, at least one processor 312 may be packaged together with logic for one or more controllers of system control logic 318 to form a System in Package (SiP). In at least one embodiment, at least one processor 312 may be integrated on the same die with logic for one or more controllers of system control logic 318. For at least one embodiment, at least one processor 312 may be integrated on the same die with logic for one or more controllers of system control logic 318 to form a System on Chip (SoC).

For touch input, touch controller 304 may include touch sensor interface circuitry 328 coupled to one or more touch sensor(s) 330 to detect touch input(s) from the user upon first touch display screen 14a and second touch display screen 14b. Touch sensor interface circuitry 328 may include any suitable circuitry that may depend, for example, at least in part on the touch-sensitive technology used for touch input device 302.

Further for touch control, touch control logic 332 may be coupled to touch sensor interface circuitry 328 to help control touch sensor interface circuitry 328 in any suitable manner to detect touch input from the user. For touch control, touch control logic 332 for at least one example embodiment may also be coupled to system control logic 318 to output in any suitable manner digital touch input data corresponding to one or more touch inputs detected by touch sensor interface circuitry 328. Touch control logic 332 may be implemented using any suitable logic, including any suitable hardware, firmware, and/or software logic (e.g., non-transitory tangible media), that may depend, for example, at least in part on the circuitry used for touch sensor interface circuitry 328.

At least one processor 312 for at least one embodiment may execute any suitable software to process digital touch input data output from touch control logic 332. Suitable software may include, for example, any suitable driver software and/or any suitable application software. Display controller 314 is configured to control the display functions of first touch display screen 14a and second touch display screen 14b.

In one or more embodiments, wearable electronic device 10 can include wireless communication module 316 (e.g., Wi-Fi module, Bluetooth™ module, near field communication (NFC) module, or other wireless communication circuitry) to allow wearable electronic device 10 to communicate with one or more other electronic devices (wearable or not wearable) on a network through a wireless connection. The wireless connection may be any 3G/4G/LTE cellular wireless connection, WiFi/WiMAX connection, Bluetooth™ connection, or some other similar wireless connection. In one or more embodiments, the wireless communication circuitry can be configured to provide for two-way radio communications with another two-way radio capable device. In an embodiment, a plurality of antennas can be provisioned in conjunction with wearable electronic device 10, which may be associated with wireless connection activities. The antennas are reflective of electrical components that can convert electric currents into radio waves or radio signals. Wearable electronic device 10 may include logic to determine a best mode of communication using various signal measurement techniques, including, but not limited to, wireless beacons (to locate one or more Wi-Fi networks), received signal strength indicator (RSSI), link quality indicator (LQI), measurement reports for one or more 3G/4G/LTE cellular wireless connections, combinations thereof or the like.

In one or more embodiments, wearable electronic device 10 may be configured to operate using a replaceable battery, or in some cases, may be configured to operate using a rechargeable battery, each of which may be housed in housing portion 16. In some embodiments, wearable electronic device 10 may include charging contacts, which can be used in combination with a charging device to facilitate charging a rechargeable battery within wearable electronic device 10. Virtually any means may be used to provide power and/or charging for wearable electronic device 10, and, thus, are clearly within the scope of the present disclosure.

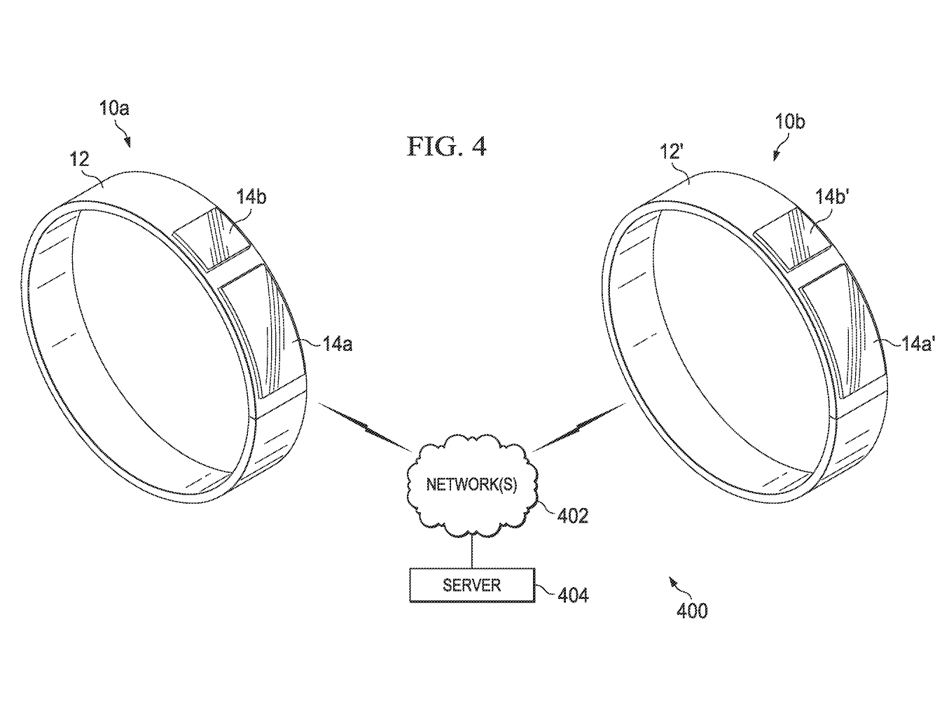

Referring now to FIG. 4, FIG. 4 is a simplified block diagram illustrating an embodiment of a communication system 400 for wireless communication between a first wearable electronic device 10a and a second wearable electronic device 10b. Communication system 400 includes wearable electronic device 10a, one or more networks 402, a server 404, and second wearable electronic device 10b. In the embodiment illustrated in FIG. 4, first wearable electronic device 10a includes first touch display screen 14a and second touch display screen 14b, and second wearable electronic device 10b includes a third touch display screen 14a′ and a fourth touch display screen 14b′. In accordance with one or more embodiments, first touch display screen 14a of first wearable electronic device 10a is associated with an corresponds to third touch display screen 14a′, and second touch display screen 14b of first wearable electronic device 10a is associated with an corresponds with fourth touch display screen 14b′. In at least one embodiment, first wearable electronic device 10a is in communication with network(s) 402 via a first wireless connection, and second wearable electronic device 10b is in communication with network(s) 402 via a second wireless connection. In particular embodiments, one or more of the first wireless connection and second wireless connection may be any 3G/4G/LTE cellular wireless, WiFi/WiMAX connection, Bluetooth™ or some other similar wireless connection. In one or more embodiments, first wearable electronic device 10a is associated with a first user, and second wearable electronic device 10b is associated with a second user.

Network(s) 402 may be a series of points or nodes of interconnected communication paths for receiving and transmitting packets of information that propagate through network(s) 402. Network(s) 402 offers a communicative interface and may include any local area network (LAN), wireless local area network (WLAN), metropolitan area network (MAN), Intranet, Extranet, WAN, virtual private network (VPN), cellular network or any other appropriate architecture or system that facilitates communications in a network environment. Network(s) 402 can comprise any number of hardware or software elements coupled to (and in communication with) each other through a communications medium.

Server 404 is in communication with network(s) 402. In one or more embodiments, server 404 is configured to receive one or more messages transmitted by first wearable electronic device 10a indicative of a touch interaction with one or more of first touch display screen 14a and second touch display 14b, and send the one or more messages to second wearable electronic device 10b. Similarly, server 404 may be configured to receive one or more messages from second wearable electronic device 10b indicative of a touch interaction with one or more of third touch display screen 14a′ and fourth tough display 14b′

In example operations associated with FIG. 4, the first user may interact with one or more of first touch display screen 14a and second touch display screen 14b of first wearable electronic device 10a. For example, the first user may type characters or input a sequence of touch inputs to one or more of first touch display screen 14a and second touch display screen 14b. First wearable electronic device 10a may then send a first message to second wearable electronic device 10b including information indicative of the interaction input and a display screen identifier for each of first touch display screen 14a and second touch display screen 14b that received an interaction input from the first user. In a particular embodiment, the first message is sent from first wearable electronic device 10a to second wearable electronic device 10b via server 404.

In response to receiving the first message from first wearable electronic device 10a, third touch display screen 14a′ of second wearable electronic device 10b may present a first representation of the input interactions provided to first touch display screen 14a of first wearable electronic device 10a. In addition, fourth touch display screen 14b′ of second wearable electronic device 10b may present a second representation of the input interactions provided to second touch display screen 14b of first wearable electronic device 10a.

In accordance with various embodiments, the second user of second wearable electronic device 10b may receive one or more input interactions to one or more of third touch display screen 14a′ and fourth touch display screen 14b′, and second wearable electronic device 10b may send a second message to first wearable electronic device 10a including information indicative of the interaction input and a display screen identifier for each of third touch display screen 14a′ and fourth touch display screen 14b′ that received an interaction input from the second user.

In response to receiving the second message from second wearable electronic device 10b, third touch display screen 14a of first wearable electronic device 10a may present a third representation of the input interactions provided to third touch display screen 14a′ of second wearable electronic device 10b. In addition, second touch display screen 14b of first wearable electronic device 10a may present a fourth representation of the input interactions provided to third touch display screen 14b′ of second wearable electronic device 10b.

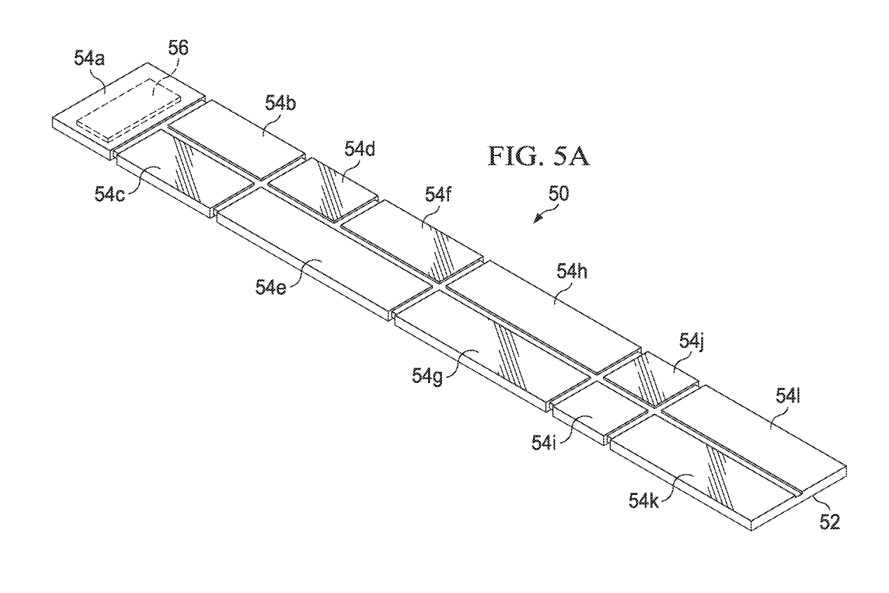

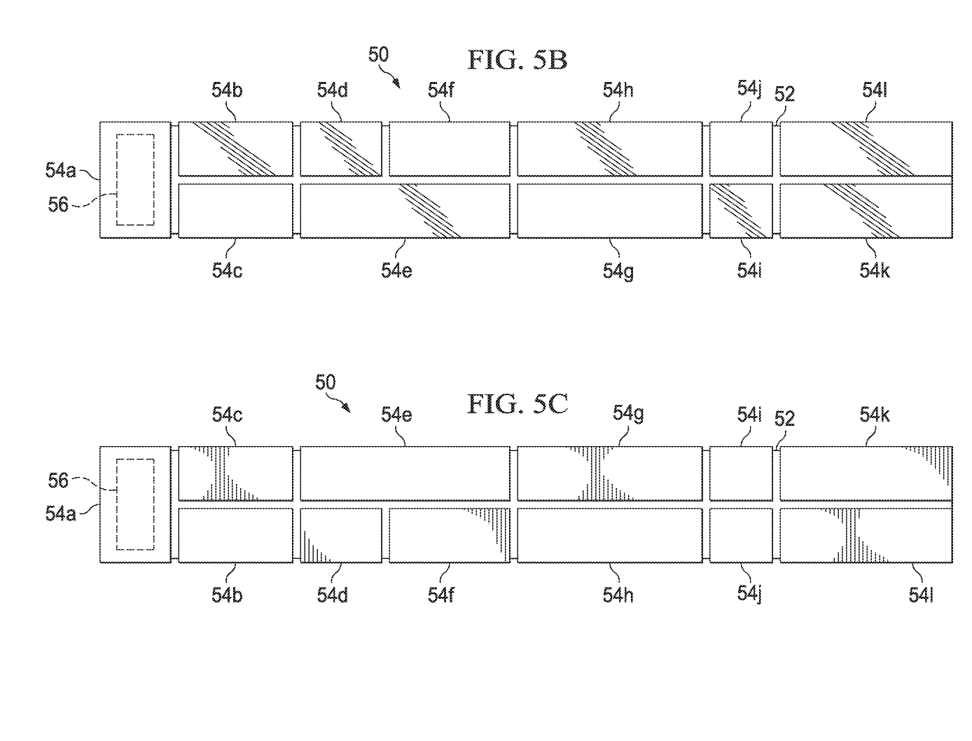

FIG. 5A is a simplified orthographic view illustrating a wearable electronic device 50 for multi-screen communication in accordance with another embodiment of the present disclosure. Wearable electronic device 50 can include a strap portion 52 having a plurality of touch display screens 54a-541 disposed at least partially on an upper surface of strap portion 52. Wearable electronic device 50 further includes a control module 56 disposed at least partially within or upon a surface of strap portion 52. Control module 56 is in communication with each of the plurality of touch display screens 54a-541.

In at least one embodiment, strap portion 52 may be of a semi-rigid construction to allow strap portion 52 to be wrapped around a wrist of a user. In still other embodiments, strap portion 52 may include clasp portion at opposing ends of strap portion 52 are configured to be coupled together to allow wearable electronic device 50 to be worn around a wrist of a user. In one or more embodiments, one or more of strap portion 52, control module 56, and touch display screens 54a-541 are composed of a flexible or semi-flexible material to allowing bending to facilitate wearing of wearable electronic device 50 around the wrist or other body portion of the user.

In one or more embodiments, strap portion 52 may be of a solid unibody construction (as shown in FIGS. 5A-5C) or may include links, chains, cables, weaves, combinations thereof or the like. The ornamental design and material construction of strap portion 52 can be adjusted in any manner to suit any designer, manufacturer and/or vendor without departing from the scope of the embodiments described in the present disclosure.

In one or more embodiments, each of touch display screens 54a-541 is a screen that can be a liquid crystal display (LCD) screen, transparent LCD screen, light-emitting diode (LED) display screen, transparent LED display screen, organic light-emitting diode (OLED) display screen, transparent LED display screen or any other suitable display screen system. In one or more embodiments, one or more of touch display screens 54a-541 include a touch input device, which may include a capacitive or resistive touch screen layer over the screen of touch display screens 54a-541.

Although the embodiment illustrated in FIG. 5A shows touch display screens 54a-541 having a relatively random pattern of screen sizes and placements, in other embodiments the touch display screens may be of a uniform size and uniform grid pattern placement. In still other embodiments the sizes and/or placements of the touch display screens may be partially random and partially uniform. Additionally, although the width of the touch display screens are shown as uniform in FIG. 5A, in some embodiments the widths of the touch display screens may include, for example, single width touch display screens adjacent to double width touch display screens, triple width touch display screens, or any other desired widths. In still other embodiments, the touch display screens may be arranged in single columns, double columns, three columns, etc. according to the desired size and/or capabilities of wearable electronic device 50.

FIG. 5B is a simplified top plan view of wearable electronic device 50 in which touch display screens 54a-541 are shown disposed on the top surface of strap portion 52 so that they may be visible when wearable electronic device 50 is being worn by the user. FIG. 5C illustrates a simplified bottom view of wearable electronic device 50 showing a bottom surface of strap portion 52.

In one or more embodiments, control module 56 of wearable electronic device 50 may further include a wireless communication module configured to communicate interactions of touch display screen 54a-541 by a user of wearable electronic device 50 with other wireless electronic devices such as another wearable electronic device associated with another user as will be further described herein.

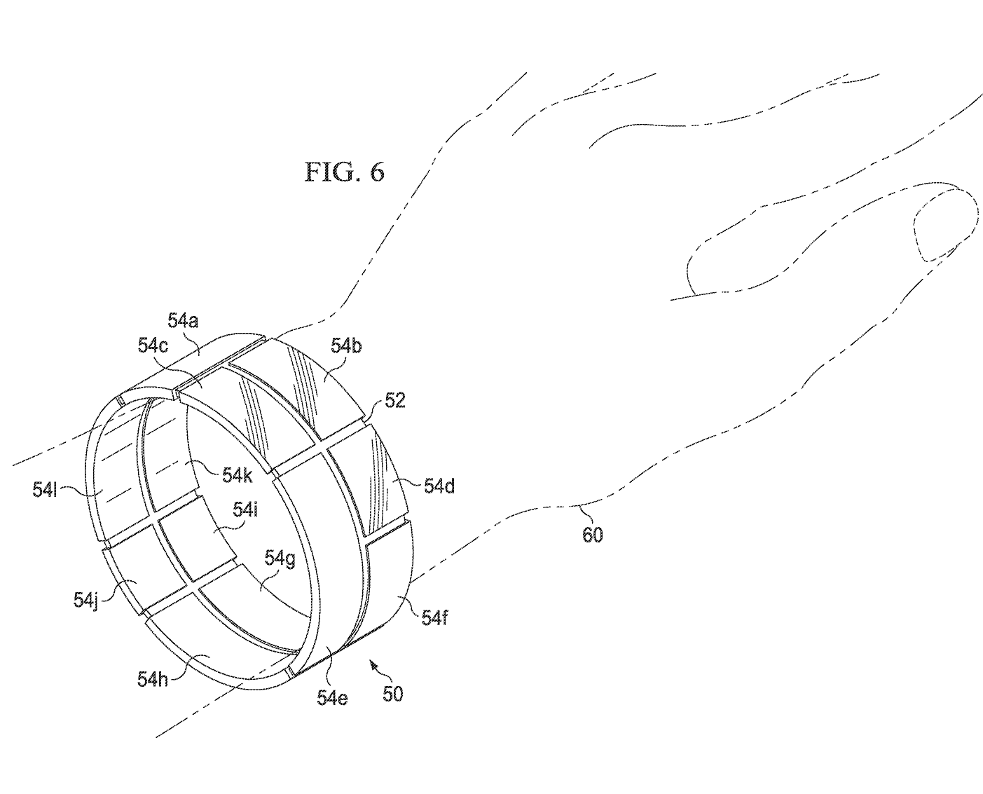

FIG. 6 illustrates an embodiment of an example procedure for multi-screen communication using wearable electronic device 50. In the embodiment illustrated in FIG. 6, wearable electronic device 50 is worn upon a wrist 60 of a user. In various embodiments, control module 56 includes a communication module configured to communicate with other wireless electronic devices such as another multi-screen wearable electronic device associated with a second user. In at least one embodiment, example logic that may be used to execute activities associated with wearable electronic device 50 may be similar to that described with respect to FIG. 3 except that first touch display screen 14a and second touch display screen 14b may be replaced with touch display screens 54a-541.

In an example operation according to one embodiment, a first user of wearable electronic device 50 may interact with one or more of touch display screens 54a-541 to create, send, view and/or reply to abstracted messages from or to another user which may activate only certain screens of the transmitting and receiving device instead of all screens of the device. In one or more embodiments, the first user of wearable electronic device 50 may interact with one or more of touch display screens 54a-54m, for example to create a single or multi-screen message, pattern, and/or design. Wearable electronic device 10 may then send a first message indicative of the message, pattern, or design to a second wearable electronic device associated with a second user having a plurality of touch display screens corresponding to touch display screens 54a-541 of wearable electronic device 50. In a particular embodiment, the second wearable electronic device includes a touch display screen that corresponds and is associated with touch display screens. In response to receiving the first message, the second wearable electronic device may activate only the screens of the second wearable electronic device that correspond to those of touch display screens 54a-541 that were used to generate the message, pattern, and/or design.

Similarly, wearable electronic device 50 may be configured to receive a message indicative of one or more touch inputs from the second user to the touch display screen of the second wearable device from the second wearable device. In response, wearable electronic device 50 may be configured to activate and present a representation of the interactions of the second user using the corresponding touch display screens 54a-541 of wearable electronic device 50 in order to replay or reproduce the interactions of the second user. The interaction with targeted screens instead of all of the screens of wearable electronic device 50 may increase the efficiency of use and may allow for a more creative and enjoyable user experience.

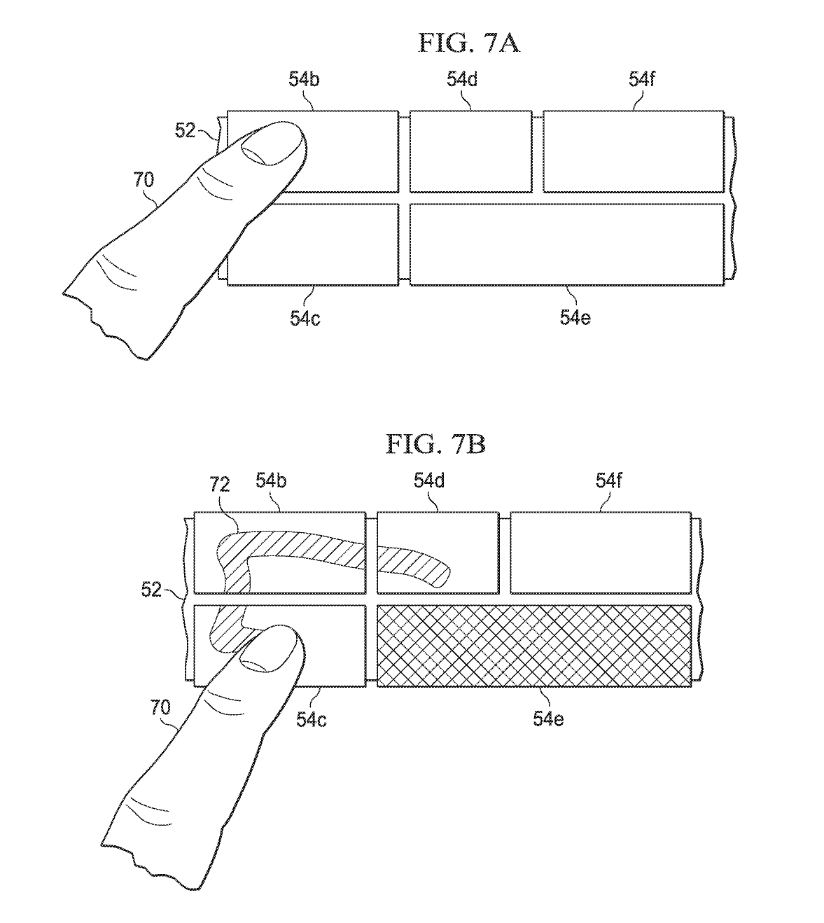

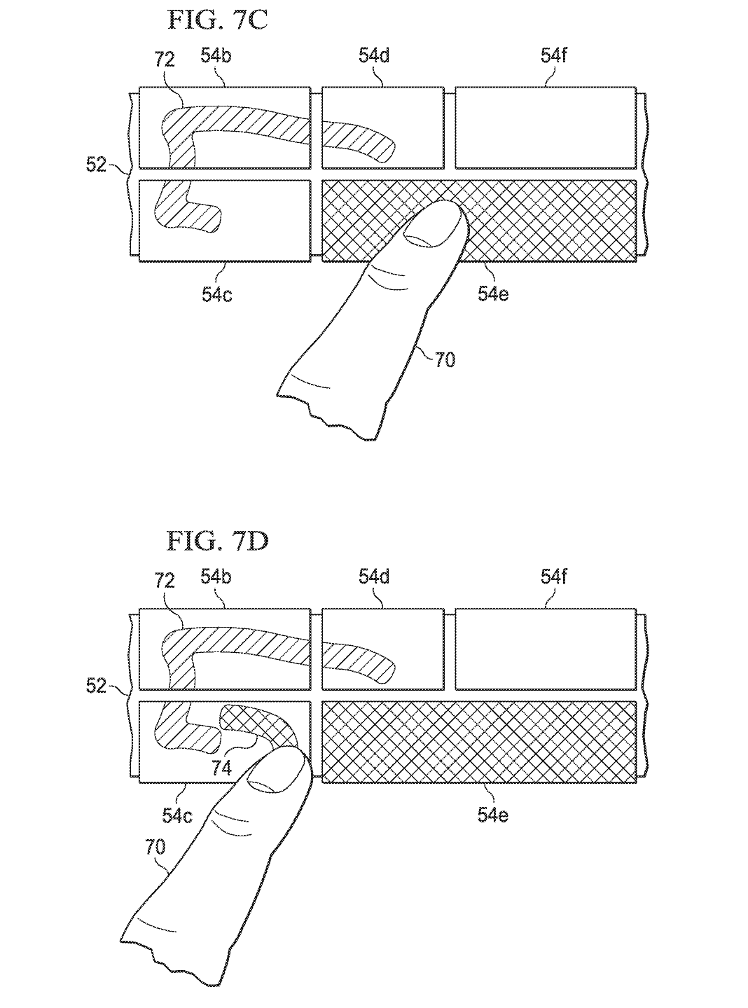

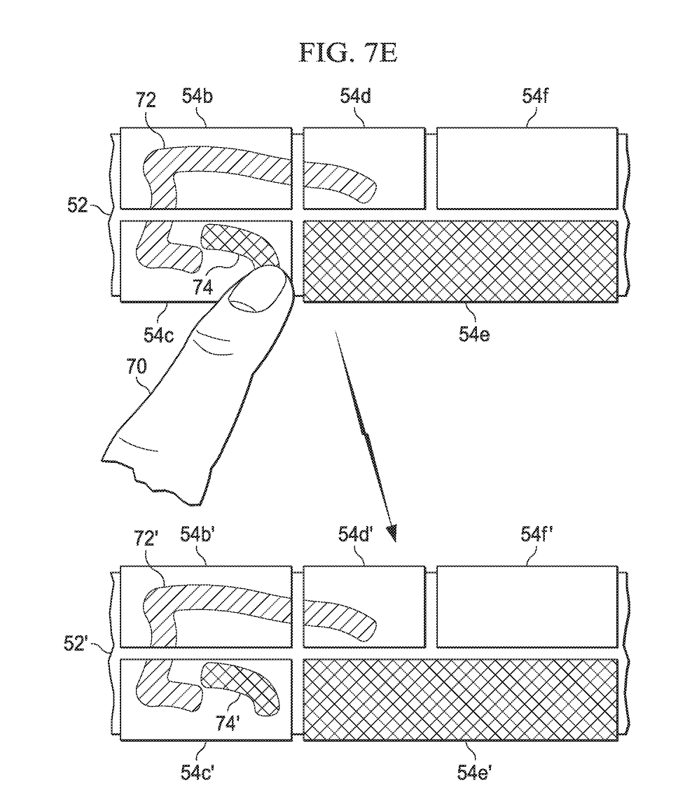

FIGS. 7A-7E illustrate example interactions of a user of wearable electronic device 50 in accordance with various embodiments. In FIG. 7A, a finger 70 of a user presses touch display screen 54d of wearable electronic device 50 cause to powering on of wearable electronic device 50. In FIG. 7B, finger 70 of the user draws a first design 72 of a first color across touch display screen 54d, touch display screen 54b, and touch display screen 54c. In FIG. 7C, finger 70 of the user selects touch display screen 54e currently displaying a second color in order to designate the second color as the current color. In FIG. 7D, finger 70 of the user draws a second design 74 of the second color across touch display screen 54c. During the drawings of first design 72 and second design 74, wearable electronic device 50 may send one or more messages indicative of the designs to a second wearable electronic device that may be configured to replay the designs using corresponding touch display screens of the second wearable electronic device. In a particular embodiment, the second wearable electronic device may display a representation of the first design 72 and second design 74 almost instantaneously with the drawing of the first design 72 and second design 74 by the user of wearable electronic device 50.

FIG. 7E illustrates an example interaction between a first wearable electronic device 50 in communication with a second wearable electronic device. FIG. 7E illustrates a strap portion 52′ and touch display screens 54b′-54f′ of the second wearable electronic device. FIG. 7E shows first design 72 and second design 74 in the process of being drawn on touch display screens 54b-54d of the first wearable electronic device and communicated to the second wearable electronic device. Upon receiving the communication, the second wearable electronic device displays a representation of first design 72 as a first representation 72′ and a representation of second design 74 as a second representation 74′ upon touch display screens 54b′-54d′ as first design 72 and second design 74 are being drawn. In an alternative embodiment, the first wearable electronic device may send the message indicative of first design 72 and second design 74 after completion of one or more of first design 72 and second design 74.

In at least one embodiment, the first wearable electronic device may communicate directly with the second wearable electronic device. In another embodiment, the first wearable electronic device may communicate with the second wearable electronic device via a server. In another embodiment, the first wearable electronic device may be tethered to a first communication device such as a first smartphone, and the second wearable electronic device may be tethered to a second communication device such as a second smartphone. In such an embodiment, the first wearable electronic device may communicate with the first communication device, the first communication device may communicate with the second communication device, and the second communication device may communicate with the second wearable electronic device. In still another embodiment, the first communication device may communicate with the second communication device via a server.

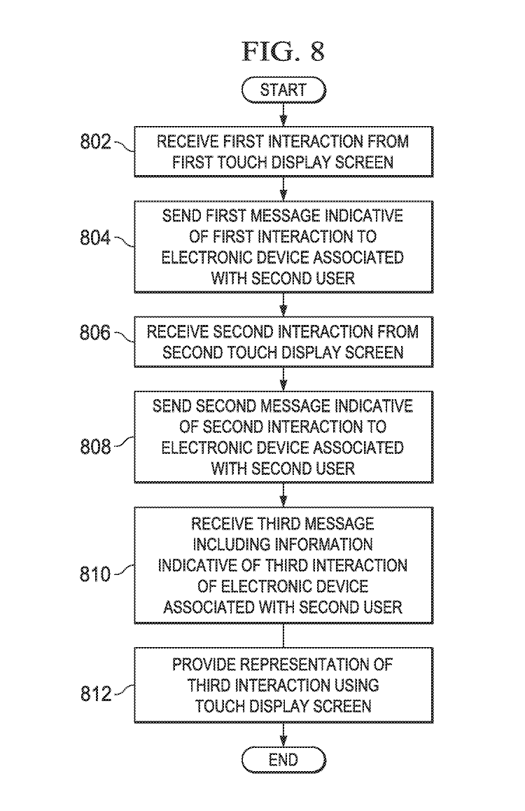

Referring now to FIG. 8, FIG. 8 is a simplified flow diagram 800 illustrating potential operations for wearable electronic device 10/50 in accordance with one embodiment of the present disclosure. In 802, control module 16 receives a first interaction from a first touch display screen of the plurality of touch display screens of the wearable electronic device. Each touch display screen is configured to display one or more images and includes a touch input device configured to receive an interaction from a first user associated with the wearable electronic device. In 804, control module 16 sends a first message including first information indicative of the first interaction and may include a first display screen identifier associated with the first touch display screen to an electronic device associated with a second user. In a particular embodiment, the wearable electronic device 10/50 may include a strap portion, wherein the plurality of touch display screens are at least partially disposed upon the strap portion. In particular embodiments, the first message further includes a first device identifier associated with the wearable electronic device. In other particular embodiments, the electronic device associated with the second user includes another wearable electronic device.

In accordance with various embodiments, the electronic device associated with the second user is configured to provide a first presentation of the first interaction using a first display screen of the electronic device associated with the second user. In still other embodiments, the first touch display screen of the wearable electronic device is associated with the first display screen of the electronic device associated with the second user.

In 806, control module 16 receives a second interaction from a second touch display screen of the plurality of display screens. In 808, control module 16 sends a second message including second information indicative of the second interaction and a second display screen identifier associated with the second touch display screen to an electronic device associated with the second user. In accordance with various embodiments, the electronic device associated with the second user is configured to provide a first presentation of the first interaction using a first display screen of the electronic device associated with the second user, and provide a second representation of the second interaction using a second display screen of the electronic device associated with the second user. In at least one embodiment, the first interaction includes a pattern of interactions provided to a plurality of the touch display screens of the wearable electronic device, and the first information of the first message is indicative of the pattern of touch inputs.

In 810, control module 16 receives a third message including third information indicative of a third interaction provided to a third display screen of the electronic device associated with the second user, and may include a third display screen identifier associated with the third display screen of the electronic device associated with the second user. In 812, the wearable electronic device provides a third presentation of the third interaction using a third touch display screen of the plurality of touch display screens and the operations end. In one or more embodiments, the third touch display screen of the wearable electronic device is associated with the third display screen of the device associated with the second user.

The example means and method described above are only a few of the many means and methods that may be used to communicate using wearable communication devices 10 and 50. Virtually any other means could be used, and, thus are clearly within the scope of the present disclosure.

Note that in some example implementations, the functions outlined herein may be implemented in conjunction with logic that is encoded in one or more tangible, non-transitory media (e.g., embedded logic provided in an application-specific integrated circuit (ASIC), in digital signal processor (DSP) instructions, software [potentially inclusive of object code and source code] to be executed by a processor, or other similar machine, etc.). In some of these instances, memory elements can store data used for the operations described herein. This can include the memory elements being able to store software, logic, code, or processor instructions that are executed to carry out the activities described herein. A processor can execute any type of instructions associated with the data to achieve the operations detailed herein. In one example, the processors could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), a DSP, an erasable programmable read only memory (EPROM), electrically erasable programmable read-only memory (EEPROM)) or an ASIC that can include digital logic, software, code, electronic instructions, or any suitable combination thereof.

Program instructions may be used to cause a general-purpose or special-purpose processing system that is programmed with the instructions to perform the operations described herein. Alternatively, the operations may be performed by specific hardware components that contain hardwired logic for performing the operations, or by any combination of programmed computer components and custom hardware components. The methods described herein may be provided as a computer program product that may include one or more non-transitory, tangible, machine readable media having stored thereon instructions that may be used to program a processing system or other electronic device to perform the methods. The term “machine readable medium” used herein shall include any medium that is capable of storing or encoding a sequence of instructions for execution by the machine and that cause the machine to perform any one of the methods described herein. The term “non-transitory machine readable medium” shall accordingly include, but not be limited to, memories* such as solid-state memories, optical and magnetic disks. Furthermore, it is common in the art to speak of software, in one form or another (e.g., program, procedure, process, application, module, logic, and so on) as taking an action or causing a result. Such expressions are merely a shorthand way of stating that the execution of the software by a processing system causes the processor to perform an action or produce a result.

It is imperative to note that all of the specifications, dimensions, and relationships outlined herein (e.g., width, length, thickness, materials, etc.) have only been offered for purposes of example and teaching only. Each of these data may be varied considerably without departing from the spirit of the present disclosure, or the scope of the appended claims. The specifications apply only to one non-limiting example and, accordingly, they should be construed as such. In the foregoing description, example embodiments have been described. Various modifications and changes may be made to such embodiments without departing from the scope of the appended claims. The description and drawings are, accordingly, to be regarded in an illustrative rather than a restrictive sense.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

### Example Embodiment Implementations

The following examples pertain to embodiments in accordance with this Specification. Note that all optional features of the apparatuses and systems described above may also be implemented with respect to the method or process described herein and specifics in the examples may be used anywhere in one or more embodiments.

Example 1 is a wearable electronic device, comprising: a plurality of touch display screens, each touch display screen configured to display one or more images and including a touch input device configured to receive a user interaction; and a control module in communication with the plurality of touch display screens, the control module including a processor configured to: receive a first interaction from a first touch display screen of the plurality of display screens; and send a first message including first information indicative of the first interaction and a first display screen identifier associated with the first touch display screen to a second electronic device.

In Example 2, the subject matter of Example can optionally include a strap portion, wherein the plurality of touch display screens are at least partially disposed upon the strap portion.

In Example 3, the subject matter of any of Examples 1-2 can optionally include wherein the first message further includes a first device identifier associated with the wearable electronic device.

In Example 4, the subject matter of any of Examples 1-3 can optionally include wherein the second electronic device includes a second wearable electronic device.

In Example 5, the subject matter of any of Examples 1-4 can optionally include wherein the second electronic device is configured to provide a first presentation of the first interaction using a first display screen of the second electronic device.

In Example 6, the subject matter of Example 5 can optionally include wherein the first touch display screen of the wearable electronic device is associated with the first display screen of the second electronic device.

In Example 7, the subject matter of any of Examples 1-6 can optionally include wherein the processor is further configured to: receive a second interaction from a second touch display screen of the plurality of display screens; and send a second message including second information indicative of the second interaction and a second display screen identifier associated with the second touch display screen to the second electronic device.

In Example 8, the subject matter of Example 7 can optionally include wherein the second electronic device is configured to provide a first presentation of the first interaction using a first display screen of the second electronic device, and provide a second representation of the second interaction using a second display screen of the second electronic device.

In Example 9, the subject matter of any of Examples 1-8 can optionally include wherein the first interaction includes a pattern of interactions provided to a plurality of the touch display screens of the wearable electronic device, and wherein the first information of the first message is indicative of the pattern of touch inputs.

In Example 10, the subject matter of any of Examples 1-9 can optionally include wherein the processor is further configured to: receive a third message including third information indicative of a third interaction provided to a third display screen of the second electronic device, and a third display screen identifier associated with the third display screen of the second electronic device.

In Example 11, the subject matter of Example 10 can optionally include wherein the processor is further configured to: provide a third presentation of the third interaction using a third touch display screen of the plurality of touch display screens, wherein the third touch display screen of the wearable electronic device is associated with the third display screen of the second electronic device.

Example 12 is a wearable electronic device comprising a plurality of touch display screens, each touch display screen configured to display one or more images and including a touch input device configured to receive a user interaction, and a control module in communication with the plurality of touch display screens, the control module including logic, at least a portion of which is partially implemented in hardware, the logic configured to: receive a first interaction from a first touch display screen of the plurality of display screens; and send a first message including first information indicative of the first interaction and a first display screen identifier associated with the first touch display screen to a second electronic device.

In Example 13, the subject matter of Example 12 can optionally include wherein the second electronic device is configured to provide a first presentation of the first interaction using a first display screen of the second electronic device.

In Example 14, the subject matter of any of Examples 12-13 can optionally include wherein the first touch display screen of the wearable electronic device is associated with the first display screen of the second electronic device.

In Example 15, the subject matter of any of Examples 12-14 can optionally include wherein the logic is further configured to: receive a second interaction from a second touch display screen of the plurality of display screens; and send a second message including second information indicative of the second interaction and a second display screen identifier associated with the second touch display screen to the second electronic device.

In Example 16, the subject matter of Example 15 can optionally include wherein the second electronic device is configured to provide a first presentation of the first interaction using a first display screen of the second electronic device, and provide a second representation of the second interaction using a second display screen of the second electronic device.

In Example 17, the subject matter of any of Examples 12-16 can optionally include wherein the first interaction includes a pattern of interactions provided to a plurality of the touch display screens of the wearable electronic device, and wherein the first information of the first message is indicative of the pattern of touch inputs.

In Example 18, the subject matter of any of Examples 12-17 can optionally include wherein the logic is further configured to: receive a third message including third information indicative of a third interaction provided to a third display screen of the second electronic device, and a third display screen identifier associated with the third display screen of the second electronic device.

In Example 19, the subject matter of Example 18 can optionally include wherein the logic is further configured to: provide a third presentation of the third interaction using a third touch display screen of the plurality of touch display screens, wherein the third touch display screen of the wearable electronic device is associated with the third display screen of the second electronic device.

Example 20 is at least one computer readable storage medium comprising instructions, wherein the instructions when executed by at least one processor cause the at least one processor to: receive a first interaction from a first touch display screen of a plurality of display screens of a wearable electronic device, wherein each touch display screen is configured to display one or more images and including a touch input device configured to receive a user interaction; and send a first message including first information indicative of the first interaction and first display screen identifier associated with the first touch display screen to a second electronic device.

In Example 21, the subject matter of Example 20 can optionally include wherein the second electronic device is configured to provide a first presentation of the first interaction using a first display screen of the second electronic device.

In Example 22, the subject matter of Example 21 can optionally include wherein the first touch display screen of the wearable electronic device is associated with the first display screen of the second electronic device.

In Example 23, the subject matter of any of Examples 20-22 can optionally include wherein the instructions, when executed by the at least one processor, further cause the at least one processor to: receive a second interaction from a second touch display screen of the plurality of display screens; and send a second message including second information indicative of the second interaction and a second display screen identifier associated with the second touch display screen to the second electronic device.

In Example 24, the subject matter of any of Examples 20-23 can optionally include wherein the instructions, when executed by the at least one processor, further cause the at least one processor to receive a third message including third information indicative of a third interaction provided to a third display screen of the second electronic device, and a third display screen identifier associated with the third display screen of the second electronic device.

In Example 25, the subject matter of Example 24 can optionally include wherein the instructions, when executed by the at least one processor, further cause the at least one processor to provide a third presentation of the third interaction using a third touch display screen of the plurality of touch display screens, wherein the third touch display screen of the wearable electronic device is associated with the third display screen of the second electronic device.

Example 26 is a method comprising: receiving a first interaction from a first touch display screen of a plurality of display screens of a wearable electronic device, wherein each touch display screen is configured to display one or more images and including a touch input device configured to receive a user interaction; and sending a first message including first information indicative of the first interaction and first display screen identifier associated with the first touch display screen to a second electronic device.

In Example 27, the subject matter of Example 26 can optionally include wherein the second electronic device is configured to provide a first presentation of the first interaction using a first display screen of the second electronic device.

In Example 28, the subject matter of Example 27 can optionally include wherein the first touch display screen of the wearable electronic device is associated with the first display screen of the second electronic device.

In Example 29, the subject matter of any of Examples 26-28 can optionally include receiving a second interaction from a second touch display screen of the plurality of display screens; and sending a second message including second information indicative of the second interaction and a second display screen identifier associated with the second touch display screen to the second electronic device.

In Example 30, the subject matter of any of Examples 26-29 can optionally include receiving a third message including third information indicative of a third interaction provided to a third display screen of the second electronic device, and a third display screen identifier associated with the third display screen of the second electronic device.

In Example 31, the subject matter of Example 30 can optionally include providing a third presentation of the third interaction using a third touch display screen of the plurality of touch display screens, wherein the third touch display screen of the wearable electronic device is associated with the third display screen of the second electronic device.

Example 32 is an apparatus comprising means for performing the method of any one of Examples 26-31.

In Example 33, the subject matter of Example 32 can optionally include wherein the means for performing the method comprise a processor and a memory.

In Example 34, the subject matter of Example 33 can optionally include wherein the memory comprises machine readable instructions, that when executed cause the apparatus to perform the method of any one of Examples 33-36.

In Example 35, the subject matter of any one of Examples 32-34 can optionally include wherein the apparatus is a computing system.

Example 36 is at least one computer readable medium comprising instructions that, when executed, implement a method or realize an apparatus as described in any one of Examples 1-19 or 26-31.

Example 37 is an apparatus comprising: means for receiving a first interaction from a first touch display screen of a plurality of display screens of a wearable electronic device, wherein each touch display screen is configured to display one or more images and including a touch input device configured to receive a user interaction; and means for sending a first message including first information indicative of the first interaction and first display screen identifier associated with the first touch display screen to a second electronic device.

In Example 38, the subject matter of Example 37 can optionally include wherein the second electronic device is configured to provide a first presentation of the first interaction using a first display screen of the second electronic device.

In Example 39, the subject matter of Example 38 can optionally include wherein the first touch display screen of the wearable electronic device is associated with the first display screen of the second electronic device.

In Example 40, the subject matter of any of Examples 37-39 can optionally include means for receiving a second interaction from a second touch display screen of the plurality of display screens; and means for sending a second message including second information indicative of the second interaction and a second display screen identifier associated with the second touch display screen to the second electronic device.

In Example 41, the subject matter of Example 40 can optionally include means for receiving a third message including third information indicative of a third interaction provided to a third display screen of the second electronic device, and a third display screen identifier associated with the third display screen of the second electronic device.

In Example 42, the subject matter of Example 41 can optionally include means providing a third presentation of the third interaction using a third touch display screen of the plurality of touch display screens, wherein the third touch display screen of the wearable electronic device is associated with the third display screen of the second electronic device.

What is claimed is:

1. A wearable electronic device, comprising:
a plurality of touch display screens, each touch display screen configured to display one or more images and including a touch input device configured to receive a user interaction; and
a control module in communication with the plurality of touch display screens, the control module including a processor configured to:
receive a first interaction from a first touch display screen of the plurality of display screens; and
send a first message including first information indicative of the first interaction and a first display screen identifier associated with the first touch display screen to a second electronic device.

2. The wearable electronic device of claim 1, further including a strap portion, wherein the plurality of touch display screens are at least partially disposed upon the strap portion.

3. The wearable electronic device of claim 1, wherein the first message further includes a first device identifier associated with the wearable electronic device.

4. The wearable electronic device of claim 1, wherein the second electronic device includes a second wearable electronic device.

5. The wearable electronic device of claim 1, wherein the second electronic device is configured to provide a first presentation of the first interaction using a first display screen of the second electronic device.

6. The wearable electronic device of claim 5, wherein the first touch display screen of the wearable electronic device is associated with the first display screen of the second electronic device.

7. The wearable electronic device of claim 1, wherein the processor is further configured to:
receive a second interaction from a second touch display screen of the plurality of display screens; and
send a second message including second information indicative of the second interaction and a second display screen identifier associated with the second touch display screen to the second electronic device.

8. The wearable electronic device of claim 7, wherein the second electronic device is configured to provide a first presentation of the first interaction using a first display screen of the second electronic device, and provide a second representation of the second interaction using a second display screen of the second electronic device.

9. The wearable electronic device of claim 1, wherein the first interaction includes a pattern of interactions provided to a plurality of the touch display screens of the wearable electronic device, and wherein the first information of the first message is indicative of the pattern of touch inputs.

10. The wearable electronic device of claim 1, wherein the processor is further configured to:
receive a third message including third information indicative of a third interaction provided to a third display screen of the second electronic device, and a third display screen identifier associated with the third display screen of the second electronic device.

11. The wearable electronic device of claim 10, wherein the processor is further configured to:
provide a third presentation of the third interaction using a third touch display screen of the plurality of touch display screens, wherein the third touch display screen of the wearable electronic device is associated with the third display screen of the second electronic device.

12. A wearable electronic device comprising a plurality of touch display screens, each touch display screen configured to display one or more images and including a touch input device configured to receive a user interaction, and a control module in communication with the plurality of touch display screens, the control module including logic, at least a portion of which is partially implemented in hardware, the logic configured to:
receive a first interaction from a first touch display screen of the plurality of display screens; and
send a first message including first information indicative of the first interaction and a first display screen identifier associated with the first touch display screen to a second electronic device.

13. The wearable electronic device of claim 12, wherein the second electronic device is configured to provide a first presentation of the first interaction using a first display screen of the second electronic device.

14. The wearable electronic device of claim 13, wherein the first touch display screen of the wearable electronic device is associated with the first display screen of the second electronic device.

15. The wearable electronic device of claim 12, wherein the logic is further configured to:
receive a second interaction from a second touch display screen of the plurality of display screens; and
send a second message including second information indicative of the second interaction and a second display screen identifier associated with the second touch display screen to the second electronic device.

16. The wearable electronic device of claim 15, wherein the second electronic device is configured to provide a first presentation of the first interaction using a first display screen of the second electronic device, and provide a second representation of the second interaction using a second display screen of the second electronic device.

17. The wearable electronic device of claim 12, wherein the first interaction includes a pattern of interactions provided to a plurality of the touch display screens of the wearable electronic device, and wherein the first information of the first message is indicative of the pattern of touch inputs.

18. The wearable electronic device of claim 12, wherein the logic is further configured to:
receive a third message including third information indicative of a third interaction provided to a third display screen of the second electronic device, and a third display screen identifier associated with the third display screen of the second electronic device.

19. The wearable electronic device of claim 18, wherein the logic is further configured to:
provide a third presentation of the third interaction using a third touch display screen of the plurality of touch display screens, wherein the third touch display screen of the wearable electronic device is associated with the third display screen of the second electronic device.

20. At least one computer readable storage medium comprising instructions, wherein the instructions when executed by at least one processor cause the at least one processor to:
receive a first interaction from a first touch display screen of a plurality of display screens of a wearable electronic device, wherein each touch display screen is configured to display one or more images and including a touch input device configured to receive a user interaction; and
send a first message including first information indicative of the first interaction and first display screen identifier associated with the first touch display screen to a second electronic device.

21. The medium of claim 20, wherein the second electronic device is configured to provide a first presentation of the first interaction using a first display screen of the second electronic device.

22. The medium of claim 21, wherein the first touch display screen of the wearable electronic device is associated with the first display screen of the second electronic device.

23. The medium of claim 20, wherein the instructions, when executed by the at least one processor, further cause the at least one processor to:
receive a second interaction from a second touch display screen of the plurality of display screens; and
send a second message including second information indicative of the second interaction and a second display screen identifier associated with the second touch display screen to the second electronic device.

24. The medium of claim 20, wherein the instructions, when executed by the at least one processor, further cause the at least one processor to receive a third message including third information indicative of a third interaction provided to a third display screen of the second electronic device, and a third display screen identifier associated with the third display screen of the second electronic device.

25. The medium of claim 24, wherein the instructions, when executed by the at least one processor, further cause the at least one processor to provide a third presentation of the third interaction using a third touch display screen of the plurality of touch display screens, wherein the third touch display screen of the wearable electronic device is associated with the third display screen of the second electronic device.
